(19) United States
(12) Patent Application Publication
(10) Pub. No.: US 2023/0207143 A1
(43) Pub. Date: Jun. 29, 2023

(54) INTERNAL ELECTRODE INSERTION DEVICE FOR WELDING EQUIPMENT FOR SKELETON OF NUCLEAR FUEL ASSEMBLY

(71) Applicant: KEPCO NUCLEAR FUEL CO., LTD., Daejeon (KR)

(72) Inventors: Byung Tak KIM, Daejeon (KR); Se Ick SON, Sejong-si, Sejong (KR); Sung Jun PARK, Gwangmyeong-si, Gyeonggi-do (KR); Je Won LEE, Daejeon (KR)

(73) Assignee: KEPCO NUCLEAR FUEL CO., LTD., Daejeon (KR)

(21) Appl. No.: 17/922,686

(22) PCT Filed: Jun. 10, 2020
(86) PCT No.: PCT/KR2020/007508

§ 371 Date: Nov. 1, 2022

(30) Foreign Application Priority Data
May 27, 2020 (KR) 10-2020-0063665

(51) Int. Cl. G21C 3/334; G21C 3/34

(52) U.S. Cl. CPC G21C 3/334; G21C 3/3424

(57) ABSTRACT

Proposed is an internal electrode insertion device for transferring the internal electrode to a welding position in order to weld a skeleton of a nuclear fuel assembly, the device including: a table; a plurality of internal electrode bars disposed in parallel in a plurality of rows on a top portion of the table; guide members provided on the table and configured to guide a horizontal movement of the internal electrode bars; guide rails provided in parallel with an alignment direction of the internal electrode bars on the top portion of the table; a driving unit provided with a servomotor thereon, thereby performing horizontal movement driving along the guide rails; and a control unit for controlling driving of the servomotor based on a preset position of each of the internal electrodes.

### TECHNICAL FIELD

The present invention relates to welding equipment for a skeleton of a nuclear fuel assembly and, more particularly, to an internal electrode insertion device for automatically transferring a plurality of internal electrodes to a welding position in welding equipment of a skeleton.

### BACKGROUND ART

Nuclear fuel used in a nuclear reactor is manufactured by forming enriched uranium into a cylindrical pellet of a predetermined size and then charging a large number of pellets into a fuel rod. In addition, the large number of such fuel rods constitute a nuclear fuel assembly and are loaded into a core of a nuclear reactor, whereby combustion thereof takes place through a nuclear reaction thereafter.

In particular, in a nuclear fuel assembly, a skeleton consisting of a spacer grid, a top nozzle assembly, a bottom nozzle assembly, an instrumentation tube, and a guide tube is a main structure of the nuclear fuel assembly and has functions such as supporting the skeleton structure and fixing the spacer grid, transmitting force in transmit in axial and transverse directions within the reactor.

In a manufacturing process of the skeleton, after fixing the spacer grids on the assembly table in place, the guide tube and the instrumentation tube are inserted into the spacer grid, and assembly is performed through bulging or welding.

Korean Patent No. 10-0526721 and Korean Patent No. 10-1630405 of the present applicant disclose an apparatus capable of improving productivity by efficiently welding a skeleton of a nuclear fuel assembly. Included in such related art are: a welding bench where a welding gun is disposed thereon, and welding is performed; and an insertion table provided on the same straight line as the welding bench.

The welding bench is provided with a plurality of spacer grids disposed thereon by being fixed at regular intervals, and the insertion table is provided on the same straight line as the welding bench, whereby the guide tube, the instrumentation tube, and the internal electrode are inserted into the spacer grid positioned on the welding bench, and thereafter, work to move the guide tube, the instrumentation tube, and the internal electrode inserted into the spacer grid to the welding position is performed.

On the other hand, the welding position of the skeleton varies depending on a fuel type, and in particular, opening and closing of the electrode of the internal electrode bar for the instrumentation tube need to be performed based on a position of a dimple of the instrumentation tube. Conventionally, a position detection sensor capable of detecting a welding position based on the fuel type is provided on the insertion table, and an installation distance of the position detection sensor is adjusted, whereby an insertion device is moved based on the detection signal so that welding is performed.

### DISCLOSURE

### Technical Problem

Accordingly, the present disclosure has been made keeping in mind the above problems occurring in a related art and relates to welding equipment for a skeleton of a nuclear fuel assembly. More particularly, the present disclosure is to provide an internal electrode insertion device for automatically transferring a plurality of internal electrodes to a welding position by excluding a separate position detecting means (sensor) for detecting a welding position in skeleton welding equipment.

### Technical Solution

In order to accomplish the above objectives, there may be provided an internal electrode insertion device for welding equipment for a skeleton of a nuclear fuel assembly (hereinafter, also abbreviated as “internal electrode insertion device”), wherein the internal electrode insertion device is for transferring internal electrodes to a welding position in order to weld the skeleton of a nuclear fuel assembly, the device includes: an insertion table; a plurality of internal electrode bars disposed in parallel in a plurality of rows on a top portion of the insertion table, each of the internal electrode bars being provided with each of the internal electrodes therein; guide members provided on the insertion table and configured to guide a horizontal movement of the internal electrode bars; guide rails provided in parallel with an alignment direction of the internal electrode bars on the top portion of the insertion table; a driving unit fixed to rear ends of the internal electrode bars and having a servomotor provided thereon, thereby performing horizontal movement driving along the guide rails; and a control unit for controlling driving of the servomotor based on a preset position of each of the internal electrodes based on a fuel type of the nuclear fuel assembly.

Preferably, the control unit may include: a memory unit having information on welding positions for fuel types of the nuclear fuel assembly stored; a setting unit configured to extract welding position information from the memory unit based on fuel type information input from the outside; and a controller configured to generate a control signal for position control to the servomotor based on the welding position information transmitted from the setting unit.

Preferably, at least one of the internal electrode bars may include: the internal electrode possibly expanded/contracted for an instrumentation tube; and a cylinder for opening/closing the electrode in the instrumentation tube for driving expansion/contraction of the internal electrode for an instrumentation tube, wherein the cylinder for opening/closing the electrode in the instrumentation tube may be expanded/contracted based on the welding position transmitted from the control unit.

### Advantageous Effects

The internal electrode insertion device according to the present invention includes a servomotor capable of performing position control of a plurality of internal electrode bars provided with an internal electrode based on a fuel type of a nuclear fuel assembly input from the outside, whereby a welding position is able to be automatically changed by the selected fuel type. Accordingly, there is an effect of simplifying the configuration of the equipment and increasing work efficiency and productivity by excluding a separate detection means for detecting a position.

### DESCRIPTION OF DRAWINGS

FIG. 1 is a perspective configuration diagram of an internal electrode insertion device according to an embodiment of the present invention.

FIG. 2 is an enlarged perspective configuration diagram of a front end of the internal electrode insertion device according to the embodiment of the present invention.

FIG. 3 is a perspective configuration diagram of a main part of a rear end of the internal electrode insertion device according to the embodiment of the present invention.

FIG. 4 is a control system block diagram of the internal electrode insertion device according to the embodiment of the present invention.

### BEST MODE

Specific structural or functional descriptions presented in embodiments of the present invention are only exemplified for a purpose of describing the embodiments according to the concept of the present invention, and the embodiments according to the concept of the present invention may be implemented in various forms. In addition, the present invention should not be construed as being limited to the embodiments described herein and should be understood to include all modifications, equivalents, and substitutes included in the spirit and scope thereof.

Hereinafter, an exemplary embodiment of the present disclosure will be described in detail with reference to accompanying drawings.

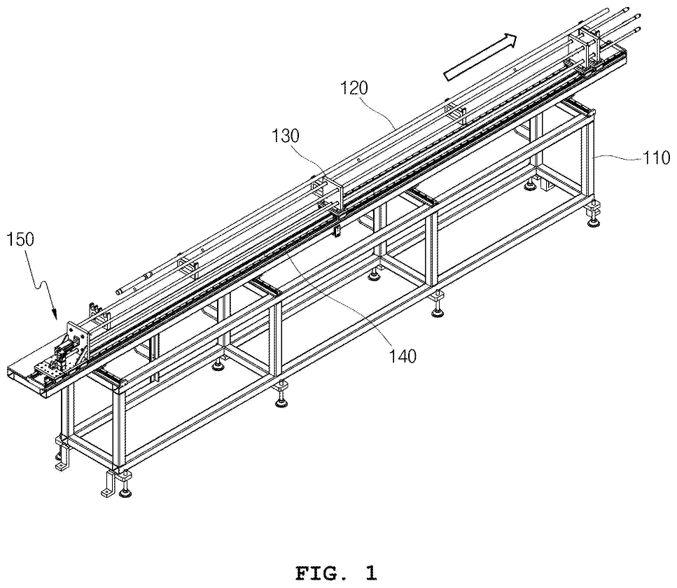

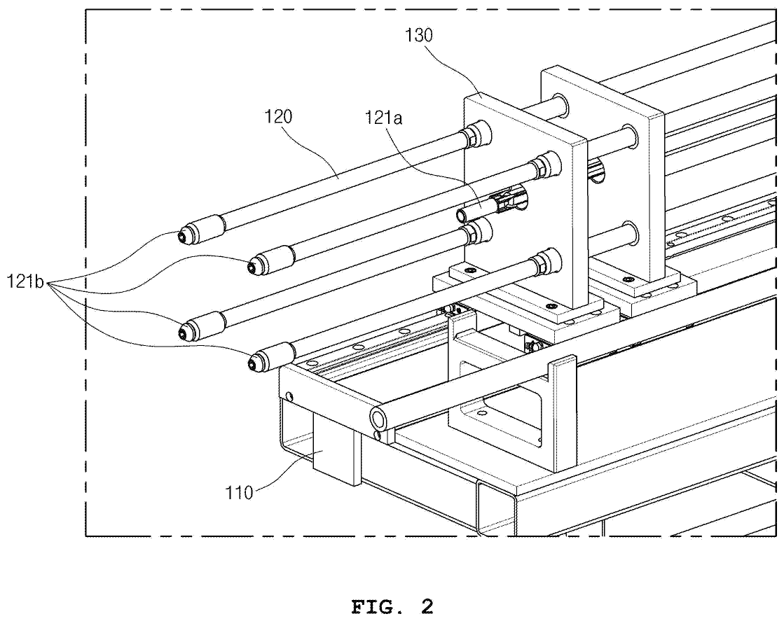

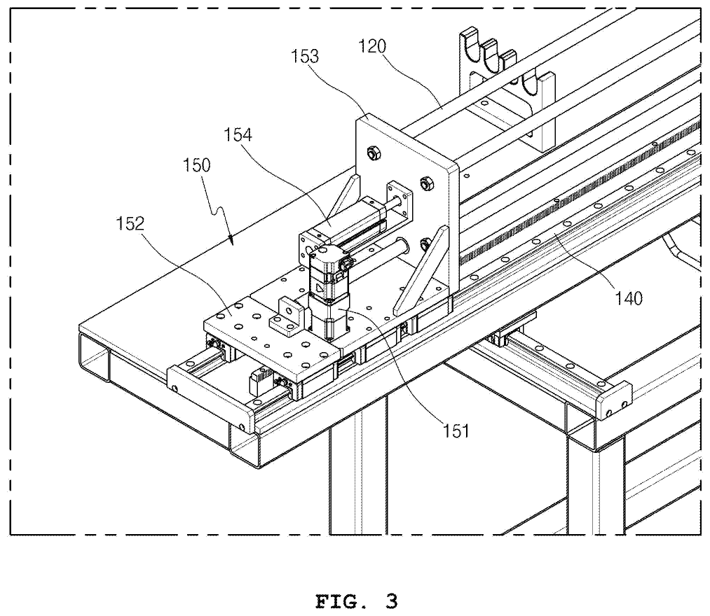

FIG. 1 is a perspective configuration diagram of an internal electrode insertion device according to an embodiment of the present invention, FIG. 2 is an enlarged perspective configuration diagram of a front end of the internal electrode insertion device according to the embodiment of the present invention, and FIG. 3 is a perspective configuration diagram of a main part of a rear end of the internal electrode insertion device according to the embodiment of the present invention.

With reference to FIGS. 1 to 3, the internal electrode insertion device of the present embodiment includes: an insertion table 110, a plurality of internal electrode bars 120 disposed in parallel in a plurality of rows on a top portion of the insertion table 110; guide members 130 provided on the insertion table 110 to guide a horizontal movement of the internal electrode bars 120; guide rails 140 provided on the top portion of the insertion table 110; a driving unit 150 for driving the internal electrode bars 120 forward and backward by performing the horizontal movement driving in front and rear along the guide rails 140; and a control unit for controlling driving of the driving unit 150.

The insertion table 110 has a length sufficient enough for the insertion operation of the guide tube, the instrumentation tube, and the internal electrodes, and the internal electrode bars 120 are aligned in a longitudinal direction of the insertion table so as to be inserted.

The insertion table 110 is arranged side by side on the same straight line as the welding bench fixed to the spacer grids, and in the following description, a direction of the insertion table adjacent to the welding bench is called a ‘front end’, and an opposite direction thereto is called a ‘rear end’. In FIG. 1, the direction of the insertion table 110 on which the driving unit 150 is disposed becomes the rear end.

In particular, with reference to FIG. 2, in the present embodiment, the internal electrode bars 120 are arranged in three rows to correspond to four guide tubes and one instrumentation tube assembled to the spacer grid and consist of a total of five. Here, an internal electrode 121a for the instrumentation tube is provided at a tip end of the internal electrode bar disposed in the middle of the second row, and an internal electrode 121b for the guide tube is provided at a tip end of each of the internal electrode bars in the first and third rows. Meanwhile, in order to pass through the dimple section provided in the instrumentation tube, the internal electrode 121a for the instrumentation tube may be expanded/contracted by a cylinder for opening/closing the electrode in the instrumentation tube to be described later.

The internal electrode bars having such a three-row structure may be simultaneously inserted into the spacer grid and welded, wherein the welding may be performed by spot welding equipment for assembling a skeleton disclosed in Korean Patent No. 10-1630405 of the present applicant.

The insertion table 110 is provided with a plurality of guide members 130 at regular intervals on the top portion thereof, wherein each of the guide members 130 is provided with the internal electrode bars 120 each horizontally positioned therein, thereby guiding the horizontal movement of the internal electrode bars 120. In the present embodiment, each of the guide members 130 is vertically fixed on the top portion of the insertion table 110 to exemplify a guide plate through which each of the internal electrode bars 120 is passed and positioned but may be variously deformed within a range that may support the smooth horizontal movement of each of the internal electrode bars 120.

The insertion table 110 is provided with guide rails 140 in the longitudinal direction on the top portion thereof, and for example, such guide rails 140 may be provided by a well-known LM guide for accurate position control of the driving unit 150.

The driving unit 150 fixes rear ends of the internal electrode bars 120 and is provided with a servomotor thereon, thereby being capable of performing accurate position control of the internal electrode bars 120 by an external control signal.

In particular, with reference to FIG. 3, In the present embodiment, the driving unit 150 includes a movable block 152 provided with a servomotor 151 and capable of moving forward and backward along the guide rails 140 and a bracket 153 configured to fix and support the internal electrode bars 120 by being vertically fixed to the movable block 152.

The driving unit 150 is controlled by the control unit, so that the accurate position control of the internal electrode provided in each of the internal electrode bars 120 is performed.

In particular, in the present invention, the control unit stores position information of the internal electrodes preset based on the fuel type of the nuclear fuel assembly (skeleton) as data and performs the position control of the driving unit 150 based on the fuel type of the nuclear fuel assembly.

Reference numeral 154 denotes the cylinder for opening/closing the electrode in the instrumentation tube, the cylinder functioning to expand/contract the internal electrode for the instrumentation tube. The cylinder for opening/closing the electrode in the instrumentation tube may also be operated by a control signal of the control unit described above.

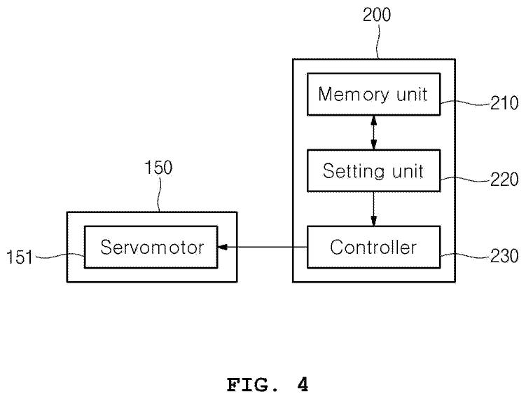

FIG. 4 is a control system block diagram of the internal electrode insertion device according to the embodiment of the present invention.

With reference to FIG. 4, the control unit 200 includes: a memory unit 210 having information on welding positions for fuel types of the nuclear fuel assembly is stored; a setting unit 220 configured to extract welding position information from the memory unit 210 based on information (fuel type) input from the outside; and a controller 230 configured to generate the control signal for position control to the servomotor 151 of the driving unit 150 based on the welding position information transmitted from the setting unit 220.

The memory unit 210 stores information by making a database of information on welding positions based on the fuel type of the nuclear fuel assembly.

The setting unit 220 includes an input means that may be input from the outside, and the fuel type of the nuclear fuel assembly is input from the outside. Thereafter, the setting unit 220 extracts the welding position information for the corresponding fuel type from the memory unit 210 and transmits the welding position information to the controller 230, whereby position control of the servomotor 151 is performed.

The present invention described above is not limited by the above-described embodiments and the accompanying drawings, and it will be clear to those who have the knowledge of common in the technical field to which the present invention pertains that various substitutions, modifications, and changes are possible within the scope without departing from the technical spirit of the present invention.

<Description of the Reference Numerals in the Drawings>

| | |
|---|---|
| 110 Insertion table | 120 Internal electrode bars |
| 121a, 121b Internal electrodes | |
| 130 Guide members | |
| 140 Guide rails | 150 Driving unit |
| 151 Servomotor | 200 Control unit |
| 210 Memory unit | 220 Setting unit |
| 230 Controller | |

1. An internal electrode insertion device for welding equipment for a skeleton of a nuclear fuel assembly, wherein the internal electrode insertion device is for transferring internal electrodes to a welding position in order to weld the skeleton of a nuclear fuel assembly, the device comprising:
an insertion table;
a plurality of internal electrode bars disposed in parallel in a plurality of rows on a top portion of the insertion table, each of the internal electrode bars being provided with each of the internal electrodes therein;
guide members provided on the insertion table and configured to guide a horizontal movement of the internal electrode bars;
guide rails provided in parallel with an alignment direction of the internal electrode bars on the top portion of the insertion table;
a driving unit fixed to rear ends of the internal electrode bars and having a servomotor provided thereon, thereby performing horizontal movement driving along the guide rails; and
a control unit for controlling driving of the servomotor based on a preset position of each of the internal electrodes based on a fuel type of the nuclear fuel assembly.

2. The device of claim 1, wherein the control unit comprises:
a memory unit having information on welding positions for fuel types of the nuclear fuel assembly stored;
a setting unit configured to extract welding position information from the memory unit based on fuel type information input from the outside; and
a controller configured to generate a control signal for position control to the servomotor based on the welding position information transmitted from the setting unit.

3. The device of claim 1, wherein at least one of the internal electrode bars comprises:
the internal electrode possibly expanded/contracted for an instrumentation tube; and
a cylinder for opening/closing the electrode in the instrumentation tube for driving expansion/contraction of the internal electrode for an instrumentation tube,
wherein the cylinder for opening/closing the electrode in the instrumentation tube is expanded/contracted based on the welding position transmitted from the control unit.
